(19) United States
(12) Patent Application Publication
(10) Pub. No.: US 2023/0115641 A1
(43) Pub. Date: Apr. 13, 2023

(54) OSCILLATING FLUIDIC PRESSURE PULSE GENERATOR

(71) Applicant: Central South University, Changsha (CN)

(72) Inventors: Xinxin ZHANG, Changsha (CN); Zhanghui WU, Changsha (CN); Shaohe ZHANG, Changsha (CN); Jingqiang TAN, Changsha (CN); Pinghe SUN, Changsha (CN); Dongyu WU, Changsha (CN)

(73) Assignee: Central South University, Changsha (CN)

(21) Appl. No.: 17/693,442

(22) Filed: Mar. 14, 2022

(30) Foreign Application Priority Data
Sep. 29, 2021 (CN) 202111155881.0

(51) Int. Cl. B01F 23/23; B01F 23/2373; B01F 31/81; F15C 1/22

(52) U.S. Cl. CPC B01F 23/238; B01F 23/2366; B01F 23/2373; B01F 31/81; F15C 1/22

(57) ABSTRACT

An oscillating fluidic pressure pulse generator, includes: an outer tube, an upper connector, a lower connector and a vortex fluidic oscillator. A first central fluid channel and a second central fluid channel are respectively formed in the upper connector and the lower connector, two ends of the outer tube are respectively connected to the upper connector and the lower connector through a screw thread, and the vortex fluidic oscillator is provided in the outer tube and abuts against the upper connector and the lower connector; and the vortex fluidic oscillator is provided with an inlet and connected to a fluidic oscillating chamber, two flow guiding blocks are arranged below the fluidic oscillating chamber, a vortex chamber inlet is formed between the two flow guiding blocks, two control channels are respectively formed outside the two flow guiding blocks, a vortex chamber is provided below the vortex chamber inlet.

### CROSS-REFERENCE TO RELATED APPLICATIONS

This application claims priority to Chinese Patent Application No. 202111155881.0 with a filing date of Sep. 29, 2021. The content of the aforementioned application, including any intervening amendments thereto, is incorporated herein by reference.

### TECHNICAL FIELD

The present disclosure relates to the technical field of downhole operation tools, and in particular, to an oscillating fluidic pressure pulse generator.

### BACKGROUND ART

Coiled tubing (CT) has been applied to all conventional and nonconventional tubing operations for its safety, reliability and high efficiency. However, CT drilling tools face a serious frictional resistance problem when drilling horizontal or directional wells. Particularly, in the case of large borehole curvature or long horizontal sections, they are unable to provide sufficient weights on bit (WOBs) due to the large frictional resistance. As a result of the high frictional resistance and difficulties in WOB transferring, the drilling efficiency is low, and complicated downhole accidents such as sticking are porn to occur. The downhole vibratory tools have proven effective in solving these problems. By using a vibratory tool, the drill string vibrates axially at a certain frequency and amplitude, which is beneficial to convert the static frictional force to the kinetic frictional force, thus reducing the frictional force between the drill strings and the borehole wall or casing. The existing oscillatory tools use the drilling fluid as the power source, converting fluid energy into mechanical energy through pressure pulse generators to produce a periodically varying pressure pulses at a certain frequency. The generated pressure pulses act on the drill string directly or by an axial oscillation mechanism to make it vibrate axially.

For the existing pressure pulse generators, descriptions can be found in literatures such as a hydraulic oscillator for drilling in the Chinese patent application No. CN 102704842 A, and a turbine-driven downhole hydraulic oscillator in the Chinese patent application No. CN 106639944 A. Mainly based on the principle of the rotary valve pulse generation, these pressure pulse generators produce pressure pulses by changing the instantaneous flow of the drilling fluid through periodically varying overlap areas between flow channels in the borehole, and transfer pulse pressure waves to the oscillation mechanism for axial vibration. However, due to the complicated structures, these pressure pulse generators have some moving parts which are easy to wear, leading to a limited service life in complicated downhole conditions. Another category vibration generators mainly based on the principle of water hammer. For example, one embodiment of the valve disclosed in U.S. Pat. No. 6,237,701 is incorporated in a drill string within a housing including high speed flow courses, an early form of measurement-while-drilling (MWD) system described by Jakosky in U.S. Pat. No. 1,963,090. Such tools interrupts flow to the bit causing pressure fluctuations in the borehole at the bit face or mud pulses in the fluid column that enhance drilling efficiency. While powerful, the in-line configurations are extremely complex and are correspondingly difficult to manufacture and assemble. Bearing seats are difficult to align, and sealing elements between them are prone to premature failure, especially in the unforgiving environments of drilling operations. The long, interconnected fluid channels and cross-holes are rapidly eroded by the drilling fluid each time the flow direction changes. Valves also suffer large pressure drops due to friction as fluid passes through long and complex channels.

### SUMMARY

An objective of the present disclosure is to provide an oscillating fluidic pressure pulse generator, to solve the problems of complicated structures, large numbers of quick-wearing spare parts, and limited service life of existing various pressure pulse generators.

To achieve the above-mentioned objective, an embodiment of the present disclosure is to provide an oscillating fluidic pressure pulse generator, including:

an outer tube, an upper connector, a lower connector and a vortex fluidic oscillator, where a central fluid channel of the upper connector and a central fluid channel of the lower connector are respectively formed in the upper connector and the lower connector, two ends of the outer tube are respectively connected to the upper connector and the lower connector through a screw thread, the vortex fluidic oscillator is provided in the outer tube, and two ends of the vortex fluidic oscillator respectively abut against the upper connector and the lower connector; and

an inlet is formed in the vortex fluidic oscillator, the inlet of the vortex fluidic oscillator is connected to a fluidic oscillating chamber, two flow guiding blocks are arranged below the fluidic oscillating chamber, a vortex chamber inlet is formed between the two flow guiding blocks, a control channel is formed outside each of the two flow guiding blocks, at least one vortex chamber is provided below the vortex chamber inlet, the vortex chamber is provided with a vortex chamber outlet, and the vortex chamber outlet communicates with the central fluid channel of the lower connector.

An upper end of the vortex fluidic oscillator may be in contact with the upper connector and sealed through a seal ring, and a lower end of the vortex fluidic oscillator may be in contact with the lower connector and tightly pressed.

An end of each of the flow guiding blocks close to the fluidic oscillating chamber may be provided with a flow guiding surface, and an end of each of the flow guiding blocks close to the vortex chamber may be provided with a fluidic wall-attaching surface.

The vortex fluidic oscillator may be an assembly of two or even more parts, or the vortex fluidic oscillator may be integrally manufactured with additive manufacturing (AM).

The vortex fluidic oscillator may consist of a substrate and a cover plate.

The substrate and the cover plate may each have a vortex chamber outlet thereon, or one of the substrate and the cover plate may have a single vortex chamber outlet thereon.

The two control channels could be symmetric with respect to an axis of the oscillating fluidic pressure pulse generator, and the control channels could communicate with the vortex chamber and the fluidic oscillating chamber, respectively.

A centroid of the vortex chamber outlet and a centroid of the vortex chamber could be radially coaxial.

When multiple vortex chambers are provided, the vortex chambers may each be provided with a vortex chamber outlet, or a lowermost vortex chamber may be provided with a vortex chamber outlet.

The fluidic oscillating chamber may be provided with a rectangular or circular-arc-shaped external contour, and the vortex chamber may be provided with a circular or circular-arc-shaped external contour.

The working principle of the present disclosure is as follows: Because of the Coanda effect, after the fluid medium is accelerated through the inlet of the fluidic oscillator, the main jet entering the fluidic oscillating chamber is deflected from a central axis of the inlet to form a deflected jet leftward or rightward, and the deflected jet flows through the flow guiding surface of the flow guiding block on one side and enters the vortex chamber through the vortex chamber inlet. Likewise, because of the Coanda effect, the fluid entering the vortex chamber is deflected toward the fluidic wall-attaching surface of the flow guiding block on the other side. The fluid medium tangentially enters the vortex chamber through the fluidic wall-attaching surface to form a clockwise or counterclockwise high-speed rotating vortex. A part of the fluid flows back to the fluidic oscillating chamber through the control channel on the opposite side of the present flow guiding block to form a recirculating flow. Due to disturbances of the recirculating flow, the main jet in the deflected jet is switched and deflected to the flow guiding surface of the flow guiding block on the other side, and the flow path of the main jet is switched to the fluidic wall-attaching surface of the flow guiding surface on the other side. By this time, the main jet impinges the vortex in the vortex chamber and weakens the vortex to cause pressure fluctuations. As the vortex declines, the fluid flows out from the vortex chamber outlet, and is gradually re-formed into an opposite vortex in the vortex chamber. Similarly, a part of fluid in the re-formed vortex returns to the fluidic oscillating chamber through the control channel, and affects the main jet again, and the above process is repeated. Due to a self-oscillating characteristic of the vortex fluidic oscillator, the oscillating fluidic pressure pulse generator generates periodic pressure fluctuations, forming pressure pulses.

The present disclosure has the following beneficial effects:

With the simple structure, the present disclosure can implement self-oscillation and generate periodic pressure fluctuations by internal flow channels only. The present disclosure can be convenient for manufacturing and is robust due to no moving parts. Compared with the pressure pulses generated by other types of pressure pulse oscillating resistance reduction devices, the fluctuation frequency and amplitude of the present disclosure can be adjusted.

### BRIEF DESCRIPTION OF THE DRAWINGS

FIG. 1 illustrates a structural view of an oscillating fluidic pressure pulse generator according to Embodiment 1 of the present disclosure;

FIG. 2 illustrates an A-A sectional view in FIG. 1 according to the present disclosure;

FIG. 3 illustrates a B-B sectional view in FIG. 1 according to the present disclosure;

FIG. 4 illustrates a C-C sectional view in FIG. 1 according to the present disclosure;

FIG. 5 illustrates a waveform of a pressure pulse in fluid simulation with an oscillating fluidic pressure pulse generator according to Embodiment 1 of the present disclosure;

FIG. 6 illustrates a structural view of an oscillating fluidic pressure pulse generator according to Embodiment 2 of the present disclosure;

FIG. 7 illustrates a structural view of an oscillating fluidic pressure pulse generator according to Embodiment 3 of the present disclosure; and

FIG. 8 illustrates a waveform of a pressure pulse in fluid simulation with an oscillating fluidic pressure pulse generator according to Embodiment 3 of the present disclosure.

### REFERENCE NUMERALS

I-upper connector, II-outer tube, III-vortex fluidic oscillator, IV-lower connector, V-substrate, VI-cover plate, 1 -central fluid channel of the upper connector, 2 -central fluid channel of the lower connector, 3 -inlet of the fluidic oscillator, 4 -fluidic oscillating chamber, 5 -flow guiding block, 6 -vortex chamber inlet, 7 -vortex chamber, 8a -left control channel, 8b -right control channel, 9 -vortex chamber outlet, 10 -exhaust channel, 11 -flow guiding surface, 12 -fluidic wall-attaching surface, 13 -special flow guiding block, 14 -second vortex chamber, 15 -second vortex chamber outlet, 16a -second left control channel, 16b -second right control channel, and 17 -central control channel.

### DETAILED DESCRIPTION OF THE EMBODIMENTS

To make the to-be-solved technical problems, technical solutions, and advantages of the present disclosure clearer, the present disclosure will be described in detail below with reference to the accompanying drawings and specific embodiments.

In view of the problems of complicated structures, large numbers of quick-wearing spare parts, and limited service lives of existing various pressure pulse generators, the present disclosure provides an oscillating fluidic pressure pulse generator.

### Embodiment 1

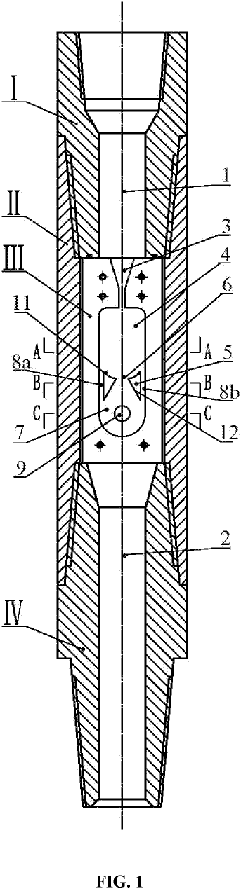

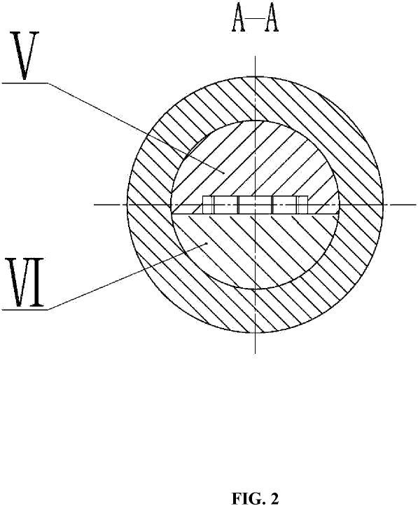

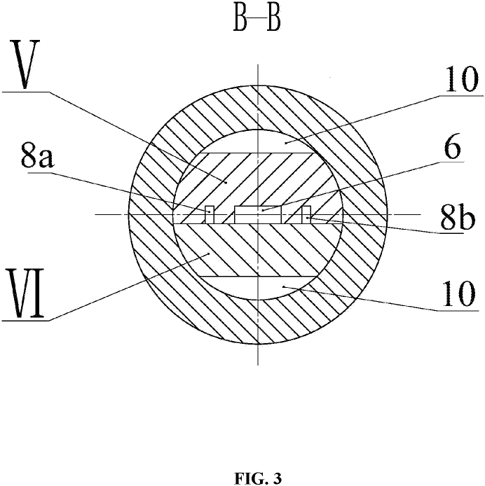

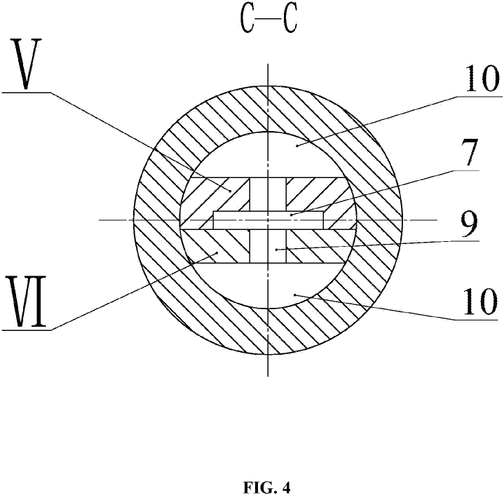

As shown in FIG. 1 to FIG. 4, the embodiment of the present disclosure provides an oscillating fluidic pressure pulse generator, including: an outer tube II, an upper connector I, a lower connector IV and a vortex fluidic oscillator III, where a central fluid channel 1 of the upper connector and a central fluid channel 2 of the lower connector are respectively formed in the upper connector I and the lower connector II, two ends of the outer tube II are respectively connected to the upper connector I and the lower connector IV through a screw thread, the vortex fluidic oscillator III is provided in the outer tube II, two ends of the vortex fluidic oscillator III respectively abut against the upper connector I and the lower connector IV, an upper end of the vortex fluidic oscillator III is in contact with the upper connector I and sealed through a seal ring, and a lower end of the vortex fluidic oscillator III is in contact with the lower connector IV and tightly pressed; an inlet 3 is formed in the vortex fluidic oscillator III, and the inlet 3 of the vortex fluidic oscillator is a tapered inlet or a straight tapered nozzle or a circular-arc-shaped inlet nozzle; the inlet 3 of the vortex fluidic oscillator is connected to a fluidic oscillating chamber 4, two flow guiding blocks 5 are arranged below the fluidic oscillating chamber 4, the flow guiding blocks 5 each is of a wedge shape, a vortex chamber inlet 6 is formed between the two flow guiding blocks 5, at least one vortex chamber 7 is provided below the vortex chamber inlet 6, a left control channel 8a and a right control channel 8b are respectively formed outside the two flow guiding blocks 5, the two control channels are symmetric with respect to an axis of the oscillating fluidic pressure pulse generator, and the control channels respectively communicate with the vortex chamber 7 and the fluidic oscillating chamber 4; and the vortex chamber 7 is provided with a vortex chamber outlet 9, the vortex fluidic oscillator III is gradually transitioned into a platy shape from a cylindrical shape on an upper portion, the platy portion and the outer tube II are formed into an exhaust channel 10, and the exhaust channel 10 respectively communicates with the vortex chamber outlet 9 and the central fluid channel 2 of the lower connector.

An end of each of the flow guiding blocks 5 close to the fluidic oscillating chamber 4 is provided with a flow guiding surface 11, the flow guiding surface 11 is of a circular-arc shape, and an end of each of the flow guiding blocks 5 close to the vortex chamber 7 is provided with a fluidic wall-attaching surface 12.

The vortex fluidic oscillator III is an assembly of two or even more parts, or the vortex fluidic oscillator III is integrally manufactured with AM. In the embodiment, the vortex fluidic oscillator III consists of a substrate V and a cover plate VI, and the substrate V and the cover plate VI are connected together through a bolt.

The substrate V and the cover plate VI each is provided thereon with a vortex chamber outlet 9, or one of the substrate V and the cover plate VI is provided thereon with a single vortex chamber outlet 9. In the embodiment, the substrate V and the cover plate VI each is provided thereon with a vortex chamber outlet 9.

A centroid of the vortex chamber outlet 9 and a centroid of the vortex chamber 7 are radially coaxial.

When multiple vortex chambers 7 are provided, the vortex chambers 7 each is provided with a vortex chamber outlet 9, or a lowermost vortex chamber 7 is provided with a vortex chamber outlet 9. In the embodiment, there is one vortex chamber 7.

The fluidic oscillating chamber 4 is provided with a rectangular or circular-arc-shaped external contour, and the vortex chamber 7 is provided with a circular or circular-arc-shaped external contour.

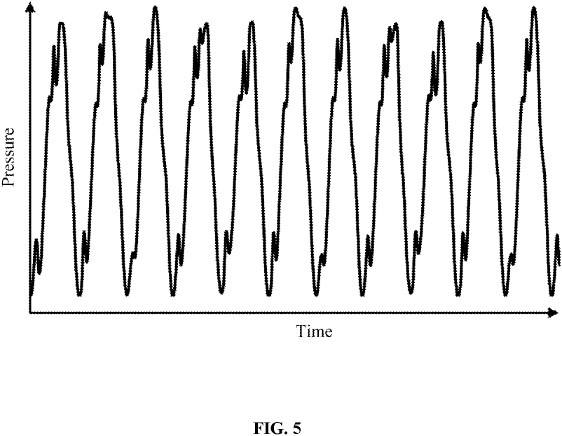

The working principle of the embodiment is as follows: Because of the Coanda effect, after the fluid medium is accelerated through the inlet 3 of the fluidic oscillator, the main jet entering the fluidic oscillating chamber 4 is deflected from a central axis of the inlet to form a deflected jet leftward or rightward, and the deflected jet flows through the flow guiding surface of the flow guiding block 5 on one side and enters the vortex chamber 7 through the vortex chamber inlet 6. Likewise, because of the Coanda effect, the fluid entering the vortex chamber 7 is deflected toward the fluidic wall-attaching surface of the flow guiding block 5 on the other side. The fluid medium tangentially enters the vortex chamber 7 through the fluidic wall-attaching surface 12 to form a clockwise or counterclockwise high-speed rotating vortex. A part of the fluid flows back to the fluidic oscillating chamber 4 through the control channel 8 on the opposite side of the present flow guiding block 5 to form a recirculating flow. Due to disturbances of the recirculating flow, the main jet in the deflected jet is switched and deflected to the flow guiding surface 11 of the flow guiding block 5 on the other side, and the flow path of the main jet is switched to the fluidic wall-attaching surface 12 of the flow guiding surface 11 on the other side. By this time, the main jet impinges the vortex in the vortex chamber 7 and weakens the vortex to cause pressure fluctuations. As the vortex declines, the fluid flows out from the vortex chamber outlet 9, and is gradually re-formed into an opposite vortex in the vortex chamber 7. Similarly, a part of fluid in the re-formed vortex returns to the fluidic oscillating chamber 4 through the control channel 8, and affects the main jet again, and the above process is repeated. Due to a self-oscillating characteristic of the vortex fluidic oscillator, the oscillating fluidic pressure pulse generator generates periodic pressure fluctuations to form pressure pulses. The pressure pulses each have a waveform as shown in FIG. 5.

### Embodiment 2

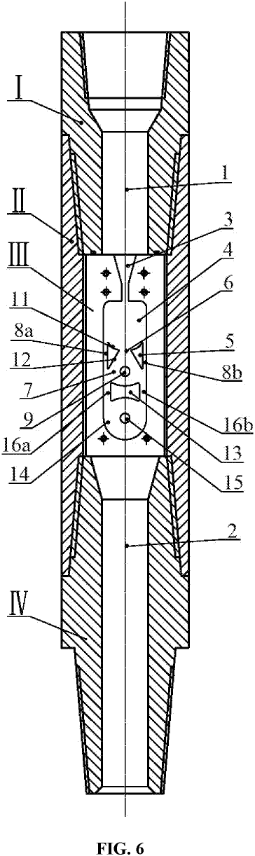

The embodiment is structurally similar to Embodiment 1, and the difference lies in that a special flow guiding block 13, a second vortex chamber 14 and a second vortex chamber outlet 15 are provided. The fluid channel of the vortex fluidic oscillator III in the embodiment is as shown in FIG. 6.

Compared with Embodiment 1, the vortex fluidic oscillator III in the embodiment is sequentially provided with one special flow guiding block 13 and one second vortex chamber 14 below the vortex chamber 7; the special flow guiding block 13 is formed into a second left control channel 16a and a second right control channel 16b with the substrate V and the cover plate VI; and the substrate V and the cover plate VI each is additionally provided thereon with one second vortex chamber outlet 15. As an improvement to the embodiment, a vortex chamber outlet communicating with the exhaust channel 10 may be provided on at least one cavity of the vortex chamber 7 and the second vortex chamber 14.

According to the fluid channel shown in FIG. 6, because of the Coanda wall attachment effect, after the fluid is accelerated through the inlet 3 of the fluidic oscillator, it is assumed that the main jet sequentially passing through the fluidic oscillating chamber 4 and the vortex chamber inlet 6 is deflected to the fluidic wall-attaching surface 12 and enters the second vortex chamber 14 through the right control channel 16b. Under the flow splitting action of the special flow guiding block 13, a part of the fluid medium enters the vortex chamber 7, and the clockwise high-speed rotating vortex is formed in the vortex chamber 7 and the second vortex chamber 14 to generate the back pressure. A part of the fluid flows back to the fluidic oscillating chamber 4 through the left control channel 8a and the second left control channel 16a to form the recirculating flow. Due to disturbances of the recirculating flow, the main jet is switched to the fluidic wall-attaching surface 12 while sweeping the flow guiding surface 11, and enters the second vortex chamber 14 through the control channel. By this time, the main jet impinges the vortex in the vortex chamber 7 and the second vortex chamber 14 and weakens the vortex to generate the pressure fluctuations. As the vortex declines, the fluid flows out from the vortex chamber outlet 9 and the second vortex chamber outlet 15, and is re-formed into a vortex and a back pressure in a counterclockwise direction, and the above process is repeated. Due to a self-oscillating characteristic of the vortex fluidic oscillator, the oscillating fluidic pressure pulse generator generates periodic pressure fluctuations to form pressure pulses.

The oscillating fluidic pressure pulse generator provided by the embodiment has the characteristics of a low oscillation frequency and a low average pressure drop. It can effectively reduce the frictional resistance of the downhole drilling tool, and is favorable to normal work of the downhole measurement-while-drilling (MWD) system.

### Embodiment 3

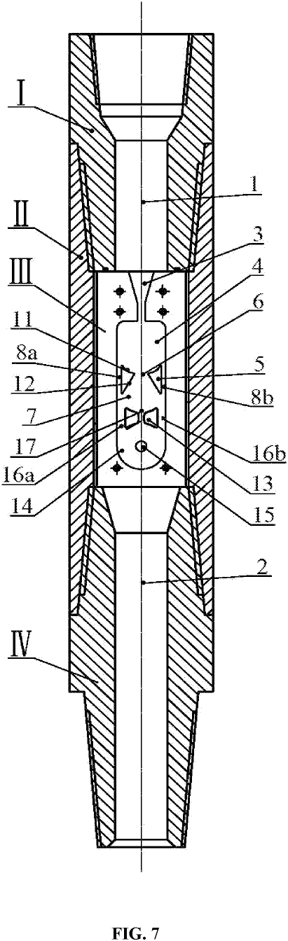

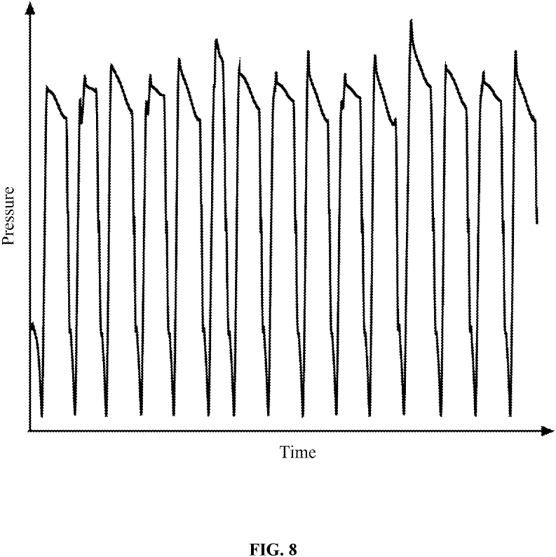

The embodiment has the basically same working principle as the vortex fluidic oscillator III in Embodiment 2. As shown in FIG. 7, the embodiment differs from Embodiment 2 in that the shape of the special flow guiding block 13 is changed, a central control channel 17 is further provided on the special flow guiding block 13, and the central control channel 17 communicates with the vortex chamber 7 and the second vortex chamber 14. The pressure waveform in Embodiment 3 is as shown in FIG. 8. Depending on different service conditions, the vortex chamber outlet may be optionally formed at the vortex chamber 7. The oscillating fluidic pressure pulse generator provided by the embodiment has the characteristics of a low frequency, and a capability of keeping the pressure near the peak for a long time, with the approximately trapezoidal pressure pulse waveform, high energy utilization rate of the fluid, and desirable effect for reducing the pressure drag of the drilling tool and transferring the WOB.

The foregoing are descriptions of preferred embodiments of the present disclosure. It should be noted that a person of ordinary skill in the art can make several improvements and modifications without departing from the principle of the present disclosure, and such improvements and modifications should be deemed as falling within the protection scope of the present disclosure.

What is claimed is:

1. An oscillating fluidic pressure pulse generator, comprising:
an outer tube, an upper connector, a lower connector and a vortex fluidic oscillator, wherein a first central fluid channel and a second central fluid channel are respectively formed in the upper connector and the lower connector, two ends of the outer tube are respectively connected to the upper connector and the lower connector through a screw thread, the vortex fluidic oscillator is provided in the outer tube, and two ends of the vortex fluidic oscillator respectively abut against the upper connector and the lower connector; and
an inlet is formed in the vortex fluidic oscillator, the inlet of the vortex fluidic oscillator is connected to a fluidic oscillating chamber, two flow guiding blocks are arranged below the fluidic oscillating chamber, a vortex chamber inlet is formed between the two flow guiding blocks, two control channels are respectively formed outside the two flow guiding blocks, at least one vortex chamber is provided below the vortex chamber inlet, the vortex chamber is provided with a vortex chamber outlet, and the vortex chamber outlet communicates with the second central fluid channel.

2. The oscillating fluidic pressure pulse generator according to claim 1, wherein an upper end of the vortex fluidic oscillator is in contact with the upper connector and sealed through a seal ring, and a lower end of the vortex fluidic oscillator is in contact with the lower connector and tightly pressed.

3. The oscillating fluidic pressure pulse generator according to claim 1, wherein an end of each of the flow guiding blocks close to the fluidic oscillating chamber is provided with a flow guiding surface, and an end of each of the flow guiding blocks close to the vortex chamber is provided with a fluidic wall-attaching surface.

4. The oscillating fluidic pressure pulse generator according to claim 1, wherein the vortex fluidic oscillator is an assembly of two or even more parts, or the vortex fluidic oscillator is integrally manufactured with additive manufacturing (AM).

5. The oscillating fluidic pressure pulse generator according to claim 4, wherein the vortex fluidic oscillator comprises a substrate and a cover plate.

6. The oscillating fluidic pressure pulse generator according to claim 5, wherein the substrate and the cover plate each is provided thereon with a vortex chamber outlet, or one of the substrate and the cover plate is provided thereon with a single vortex chamber outlet.

7. The oscillating fluidic pressure pulse generator according to claim 1, wherein the two control channels are symmetric with respect to an axis of the oscillating fluidic pressure pulse generator, and the control channels respectively communicate with the vortex chamber and the fluidic oscillating chamber.

8. The oscillating fluidic pressure pulse generator according to claim 1, wherein a centroid of the vortex chamber outlet and a centroid of the vortex chamber are radially coaxial.

9. The oscillating fluidic pressure pulse generator according to claim 1, wherein when multiple vortex chambers are provided, the vortex chambers each is provided with the vortex chamber outlet, or a lowermost vortex chamber is provided with the vortex chamber outlet.

10. The oscillating fluidic pressure pulse generator according to claim 1, wherein an external contour of the fluidic oscillating chamber is rectangular or circular-arc-shaped, and an external contour of the vortex chamber is circular or circular-arc-shaped.
